(19) United States
(12) Patent Application Publication
(10) Pub. No.: US 2011/0229355 A1
(43) Pub. Date: Sep. 22, 2011

(54) FUEL PUMP

(75) Inventors: Tetsuya HARA, Nagoya-city (JP); Yuuichi MINAMIGUCHI, Chita-gun (JP)

(73) Assignee: Aisan Kyogo Kabushiki Kaisha, Obu-city (JP)

(21) Appl. No.: 13/048,034

(22) Filed: Mar. 15, 2011

(30) Foreign Application Priority Data
Mar. 18, 2010 (JP) 2010-063086

(51) Int. Cl. F04B 35/04; B23P 11/02

(52) U.S. Cl. 417/410.1; 29/446

(57) ABSTRACT

A fuel pump has collar members, which are inserted in end portions of brush insertion holes of an end cover on an opposite side from brushes. The fuel pump has brush terminals press-fitted into the collar members. The brush terminals are connected to annular terminals, which are inserted in a secondary mold member by molding. Tip end portions of the collar members are press-fitted into the secondary mold member. Because of the press-fitting, an insulative resin intervenes between the brush terminals or between the annular terminals, to which different voltages are applied. Accordingly, passage of a leak current through fuel can be prevented, and electric corrosion can be prevented.

### CROSS REFERENCE TO RELATED APPLICATION

This application is based on and incorporates herein by reference Japanese Patent Application No. 2010-63086 filed on Mar. 18, 2010.

### BACKGROUND OF THE INVENTION

1. Field of the Invention

The present invention relates to a fuel pump for supplying fuel to an engine of an automobile.

2. Description of Related Art

In a conventional fuel pump described in Patent document 1 (U.S. Pat. No. 5,013,222), a brush assembly of a motor for driving a pump is immersed in fuel. FIG. 25 is a partial cross-sectional view showing the fuel pump described in Patent document 1. Brushes 295, 296 are accommodated respectively in brush insertion holes 280, 281 of an end cover 220 made of a synthetic resin.

The brushes 295, 296 have pigtails 297, 298 respectively. Brass brush terminals 205, 206 are connected to tip end portions of the pigtails 297, 298 respectively. Sealing rings 205a, 206a are attached respectively to the brush terminals 205, 206 to prevent a fuel leakage.

The end cover 220 is covered with a RFI module 207 having a cylindrical wall 200. Annular terminals 240, 241 are embedded in the RFI module 207. The annular terminals 240, 241 respectively have cylindrical ring portions 246, 247, which are electrically connected with the brush terminals 205, 206.

In this way, the assembly is constructed of the two resin molded products of the end cover 220 and the RFI module 207. When the end cover 220 and the RFI module 207 are assembled, first, the brushes 295, 296, the pigtails 297, 298, brush springs 201, 202 and inner elements 205b, 206b are inserted into the brush insertion holes 280, 281 of the end cover 220.

Then, the brush terminals 205, 206 are screwed to the inner elements 205b, 206b. Fuel leakage is prevented by the sealing rings 205a, 206a. Further, the RFI module 207 having the cylindrical ring portions 246, 247 are press-fitted into the end cover 220 until a tip end of the cylindrical wall 200 contacts the end cover 220 such that the cylindrical ring portions 246, 247 are electrically connected with the brush terminals 205, 206.

Voltages of different polarities are applied to the cylindrical ring portions 246, 247 of the annular terminals 240, 241 during an operation of the fuel pump. A stepped cylindrical portion 208 is provided in the end cover 220. An outer tip end surface 203 of the cylindrical portion 208 faces a resin protrusion 204a between the cylindrical ring portions 246, 247 across a gap 204.

According to Patent document 2 (JP-A-2008-64029) or Patent document 3 (JP-A-2008-64030), a pair of metals having a potential difference, which is a cause of electric corrosion, are covered with a synthetic resin by molding such that surfaces of the metals are not exposed to the fuel.

FIGS. 26A and 26B show the construction of Patent documents 2 and 3. FIG. 26A is a front view showing an assembly including an end cover. FIG. 26B is a right side view showing the assembly. As shown in FIGS. 26A and 26B, the assembly includes a bearing holder 306 having a brush holding portion 305 for holding brushes 395, 396, pigtails 397, 398 and brush springs 301, 302. The bearing holder 306 further has an insertion protrusion 386, which is inserted into a housing (not shown), on a side opposite from the brush holding portion 305.

In a state where the brushes 395, 396, parts of the pigtails 397, 398 and the brush springs 301, 302 are accommodated in the brush holding portion 305, a tip end of a resin part of the brush holding portion 305 is assembled to a mold member 360 to achieve close contact therebetween. At this time, a load receiving portion 360a of the mold member 360 contacts ends of the brush springs 301, 302 and receives forces due to elastic deformation.

Connecting portions 307, 308 of brush terminals are connected to the pigtails 397, 398 connected to the brushes 395, 396. Parts of external connection terminals 330, 331, choke coils and the brush terminals having the connecting portions 307, 308 are embedded in the mold member 360 by molding.

The bearing holder 306 fixed with the mold member 360 is covered with an end cover 320 having a fuel discharge hole portion 323. Thus, the end cover 320 is combined with the bearing holder 306. At that time, tip ends of the external connection terminals 330, 331 penetrate through the end cover 320 and extend to an outside.

The construction described in Patent document 1 has an advantage that the assembly can be constructed of the two resin molded products of the end cover 220 and the RFI module 207. However, although the construction of Patent document 1 has the sealing rings 205a, 206a, the fuel accumulates in the gap 204 if the fuel pump is used for a long time.

If a highly conductive component is contained in the fuel, current can flow between the cylindrical ring portions 246, 247 through the highly conductive component in the fuel. In this case, there is a possibility that electric corrosion begins at the gap 204 and spreads in metallic members around the gap 204. In some cases, the electric corrosion can lead to degradation of the function of the fuel pump such as defective conduction or breakage. The problem can become specifically serious in the case where a gasoline alternative such as alcohol is used as the fuel.

Such the problem of the technology of Patent document 1 is caused because the leak current flows through the fuel and because the cylindrical ring portions 246, 247, which are metals having the potential difference, are not electrically separated from each other completely. The above-described construction of Patent documents 2 and 3 aims to solve this problem.

In the construction of Patent documents 2 and 3, a pair of metals having a potential difference, which is a cause of the electric corrosion, are covered with a synthetic resin by the molding such that surfaces of the metals are not exposed to the fuel. Thus, the metals having the potential difference are electrically separated from each other completely.

However, the construction of Patent documents 2 and 3 requires the three components of the bearing holder 306, the mold member 360 and the end cover 320 in the assembly process. Therefore, the number of components is large, and there is a possibility that assembly work is complicated.

### SUMMARY OF THE INVENTION

It is an object of the present invention to provide a fuel pump, that inhibits occurrence of electric corrosion, that reduces the number of parts by restricting the number of necessary resin molded products to two, and that facilitates assembly work.

According to a first example aspect of the present invention, a fuel pump for pressurizing fuel by driving a rotational member in a pump housing with a motor is manufactured as follows. That is, a first member is formed from brushes, which a rectifier of the motor slidably contacts, an end cover, which has brush insertion holes for receiving the brushes and which is connected to a housing accommodating the motor, collar members partly inserted in the end cover at end portions of the brush insertion holes on an opposite side from the brushes by insert molding such that tip ends of the collar members protrude from the end cover, and brush terminals inserted into the collar members and connected to the brushes. A second member is formed from annular terminals, external terminals, which are connected to the annular terminals and supplied with an electric power from an outside of the fuel pump, a primary mold member for partly covering the external terminals and the annular terminals, and a secondary mold member, which covers the primary mold member such that the secondary mold member covers parts of the annular terminals and which has a connector portion surrounding the external terminals. The secondary mold member is combined to the end cover to press-fit the brush terminals into the annular terminals. The tip end portions of the collar members are press-fitted into the secondary mold member around the annular terminals.

According to the above-described aspect of the present invention, since the collar members are press-fitted into the secondary mold member, close contact between the collar members and an insulating resin of the secondary mold member is secured. Thus, the fuel can be prevented from intervening between electrode portions of the brush terminals or the annular terminals having a potential difference. Therefore, the electrode portions can be electrically separated from each other completely. Even if the highly conductive component exists in the fuel, the leak current does not flow, so the electric corrosion can be prevented.

According to a second example aspect of the present invention, the brush terminals are press-fitted into the collar members to prevent the brush terminals from coming off and to, prevent entrance of the fuel.

According to the above-described aspect of the present invention, the press-fitting between the collar members and the brush terminals secures strength for preventing the brush terminals from coming off and for preventing the entrance of the pressurized fuel.

According to a third example aspect of the present invention, the annular terminals have cylindrical ring portions. The brush terminals protrude further than the tip end portions of the collar members to an outside and are press-fitted into the cylindrical ring portions.

According to the above-described aspect of the present invention, the brush terminals, which protrude further than the tip end portions of the collar members to an outside, are press-fitted into the cylindrical ring portions. Therefore, electrical and mechanical connection between the annular terminals and the brush terminals can be strengthened.

According to a fourth example aspect of the present invention, the end cover has a planar portion integrated with a fuel discharge hole portion, from which the fuel from a fuel passage around the motor is discharged, and has a recessed portion recessed in an axial, direction of the motor from the planar portion adjacent to the fuel discharge hole portion. The secondary mold member is inserted in the recessed portion of the end cover to be combined with the end cover.

According to the above-described aspect of the present invention, the secondary mold member is inserted into the recessed portion of the end cover, and the end cover and the secondary mold member are press-fitted. Thus, assembly, of the end cover and the secondary mold member is facilitated and a coupling force therebetween can be strengthened.

According to a fifth example aspect of the present invention, the end cover has a guiding protrusion that faces one wall surface of the recessed portion and that provides the other wall surface of the recessed portion. The other wall surface of the recessed portion is formed to be lower than the one wall surface of the recessed portion.

According to the above-described aspect of the present invention, the other wall surface is lower than the one wall surface. Therefore, the secondary mold member can be positioned by bringing the secondary mold member into contact with the higher one wall surface. Accordingly, the secondary mold member can be easily inserted into the recessed portion.

According to a sixth example aspect of the present invention, a manufacturing method of a fuel pump having a motor, which is accommodated in a housing and which drives a rotational member in a pump housing, includes the steps of forming an end cover by insert molding such that the end cover has brush insertion holes for receiving brushes, which slidably contact a rectifier of the motor, and such that collar members except tip portions thereof are inserted in the brush insertion holes press-fitting brush terminals connected with the brushes into the collar members in the brush insertion holes of the molded end cover, molding a primary mold member to cover parts of a pair of external terminals, via which an electric'power is supplied to the motor from an outside of the fuel pump, and parts of, a pair of annular terminals connected to the external terminals with the primary mold member such that the other parts of the external terminals and the other parts of the annular terminals are exposed to an outside of the primary mold member, molding a secondary mold member around the primary mold member to form a connector portion, which surrounds the external terminals, with the secondary mold member, and assembling the secondary mold member to the end cover such that the tip end portions of the collar members are press-fitted into the secondary mold member around the annular terminals and such that the brush terminals of the end cover are press-fitted into the annular terminals.

According to the above-described aspect of the present invention, the collar members are inserted into the brush insertion holes of the end cover constituting the first member. The brush terminals connected with the brushes are press-fitted into the collar members. The secondary mold member constituting the second member is assembled to the end cover constituting the first member. The tip end portions of the collar members are press-fitted into the secondary mold member around the annular terminals. The brush terminals of the end cover are press-fitted into the annular terminals. In this way, the assembly having the sealing structure for preventing the entrance of the fuel can be manufactured only by assembling the two members of the first member and the second member. The assembly can prevent the passage of the leak current via the fuel, thereby preventing the electric corrosion.

According to a seventh example aspect of the present invention, the molding the primary mold member is performed to cover the pair of external terminals and the pair of annular terminals with the primary mold member in a state where the pair of external terminals are connected with each other via a connecting portion and the pair of annular terminals are connected with each other via another connecting portion. The manufacturing method further includes the step of cutting the connecting portions after the molding the primary mold member and before the molding the secondary mold member.

According to the above-described aspect of the present invention, the molding is applied to the pair of external terminals and the pair of annular terminals with the primary mold member in the state where the pair of external terminals and the pair of annular terminals are connected with each other respectively via the connecting portions. Therefore, the components are not scattered and the molding is facilitated. After the cutting, the primary mold member maintains the connection between the components. Therefore, the components are not scattered. Thus, the following molding of the secondary mold member is facilitated.

### BRIEF DESCRIPTION OF THE DRAWINGS

Features and advantages of an embodiment will be appreciated, as well as methods of operation and the function of the related parts, from a study of the following detailed description, the appended claims, and the drawings, all of which form a part of this application. In the drawings:

FIG. 1 is a partial cutaway outline view showing a fuel pump according to an embodiment of the present invention;

FIG. 2 is a longitudinal partial cross-sectional view showing the fuel pump according to the embodiment;

FIG. 3 is a front view showing an energization part during a manufacturing process according to the embodiment;

FIG. 4 is a plan view showing the energization part of FIG. 3;

FIG. 5 is a right side view showing the energization part of FIG. 3;

FIG. 6 is a schematic perspective view showing the energization part according to the embodiment;

FIG. 7 is a front view showing a primary terminal constituting member according to the embodiment;

FIG. 8 is a plan view showing the primary terminal constituting member of FIG. 7;

FIG. 9 is a bottom view showing the primary terminal constituting member of FIG. 7;

FIG. 10 is a right side view showing the primary terminal constituting member of FIG. 7;

FIG. 11 is a schematic perspective view showing the primary terminal constituting member according to the embodiment;

FIG. 12 is a front view showing a secondary terminal constituting member according to the embodiment;

FIG. 13 is a plan view showing the secondary terminal constituting member of FIG. 12;

FIG. 14 is a right side view showing the secondary terminal constituting member of FIG. 12;

FIG. 15 is a back view showing the secondary terminal constituting member of FIG. 12;

FIG. 16 is a bottom view showing the secondary terminal constituting member of FIG. 12;

FIG. 17 is a schematic perspective view showing the secondary terminal constituting member according to the embodiment;

FIG. 18 is a front view showing an end cover according to the embodiment;

FIG. 19 is a plan view showing the end cover of FIG. 18;

FIG. 20 is a right side view showing the end cover of FIG. 18;

FIG. 21 is a bottom view showing the end cover of FIG. 18;

FIG. 22 is a front view showing an assembly of the secondary terminal constituting member and the end cover according to the embodiment;

FIG. 23 is a plan view showing the assembly of FIG. 22;

FIG. 24 is an enlarged partial cross-sectional view showing the assembly of FIG. 23 taken along the line XXIV-XXIV;

FIG. 25 is an enlarged partial cross-sectional view showing a fuel pump of a prior art;

FIG. 26A is an, exploded front view showing an assembly of another prior art; and

FIG. 26B is a exploded right side view showing the assembly of FIG. 26A.

### DETAILED DESCRIPTION OF EXAMPLE EMBODIMENT

### Embodiment

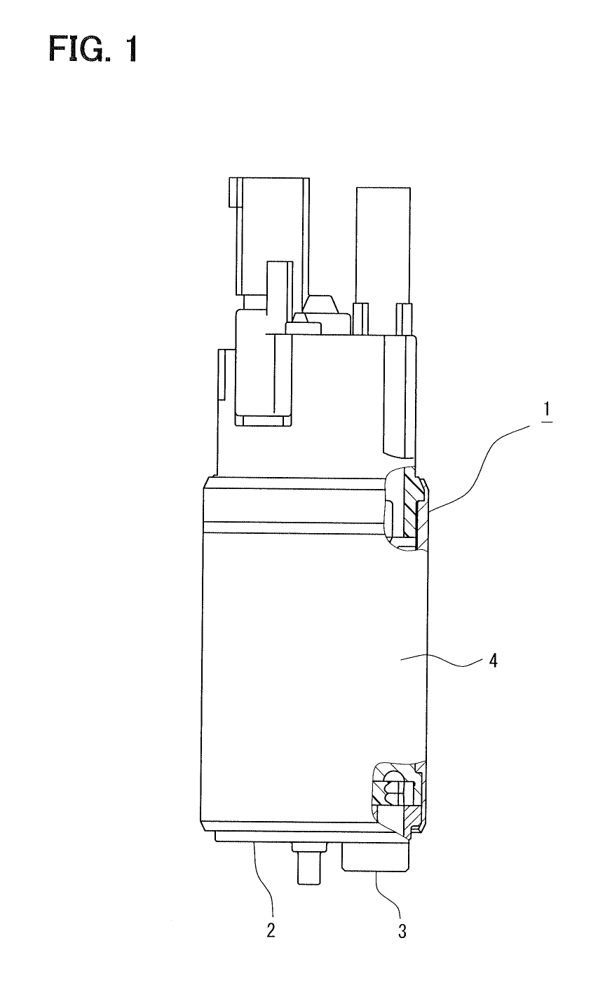

Hereinafter, an embodiment of the present invention will be explained in detail with reference to FIGS. 1 to 24. In the present embodiment, in order to solve a problem of electric corrosion in brush terminals while maintaining a two-member construction composed of a first member and a second member, insert molding is performed such that collar members are inserted in an end cover, which constitutes the first member. Thus, according to the present embodiment, anti-electric corrosion sealing can be achieved with the simple two-member construction. Hereinafter, first, an entire construction of a fuel pump will be explained.

(Entire Construction)

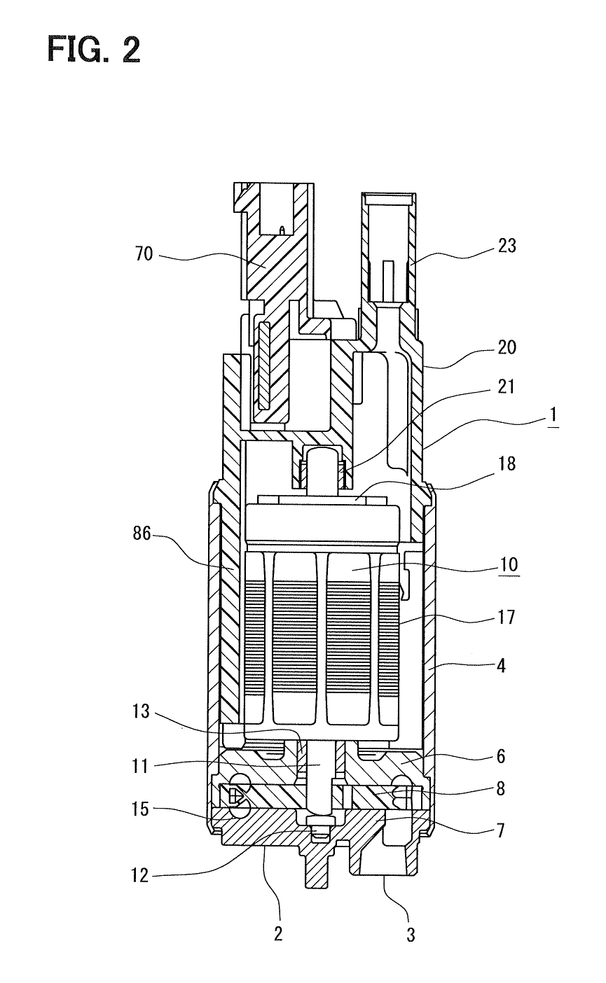

FIG. 1 is a partial cutaway outline view showing a fuel pump 1 according to the present embodiment. FIG. 2 is a longitudinal partial cross-sectional view showing the fuel pump 1 according to the present embodiment. The fuel pump 1 shown in FIG. 1 is an in-tank pump mounted in a fuel tank.

As shown in FIG. 1, a suction opening 3 is formed in a bottom portion 2 of the fuel pump 1. A filter (not shown) is attached to the suction opening 3. The fuel pump 1 has a cylindrical metallic housing 4. As shown in FIG. 2, a pair of pump housings 6, 7 are provided in the housing 4 and constitute a regenerative pump.

An impeller 8 constituting a rotational member is rotatably accommodated between the pump housing 6, 7. The impeller 8 is connected with a rotational shaft 11 of a motor 10 of the fuel pump 1. Thus, the impeller 8 can rotate together with the rotational shaft 11. The fuel pump 1 has a thrust bearing 12 and a bearing 13, which are held by the pump housings 6, 7 as shown in FIG. 2.

A pump flow passage 15 in the shape of a circle is formed in the pump housings 6, 7 on both of a front side and a back side of a peripheral portion of the impeller 8. A partition portion (not shown) is, formed in the pump flow passage 15. The suction opening 3 and a discharge opening (not shown) are provided across the partition portion. The fuel pressurized in the pump flow passage 15 and discharged from the discharge opening flows through a circumference of an armature 17 of the motor 10.

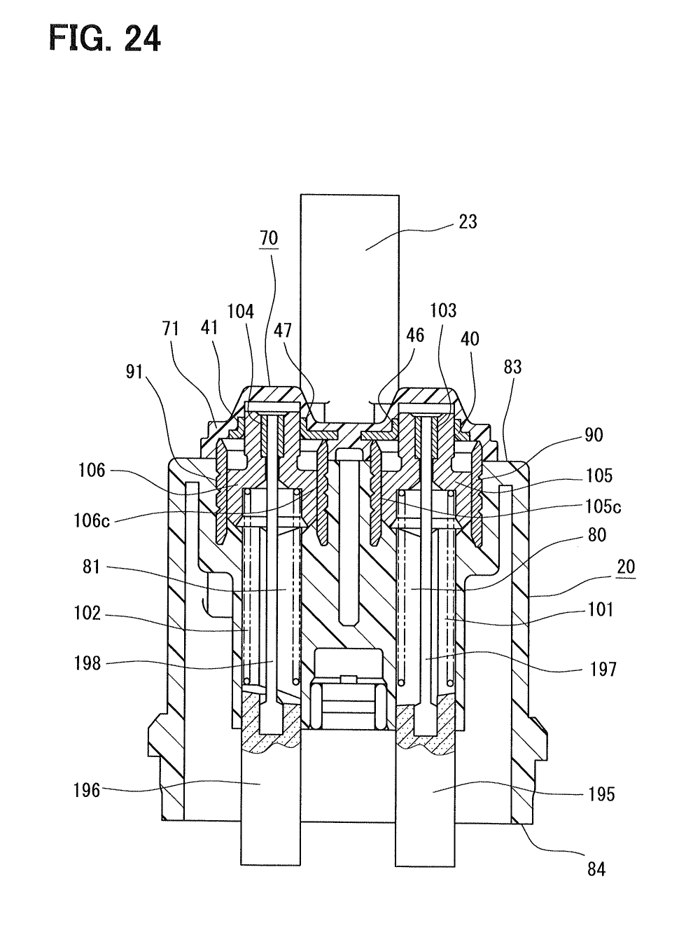

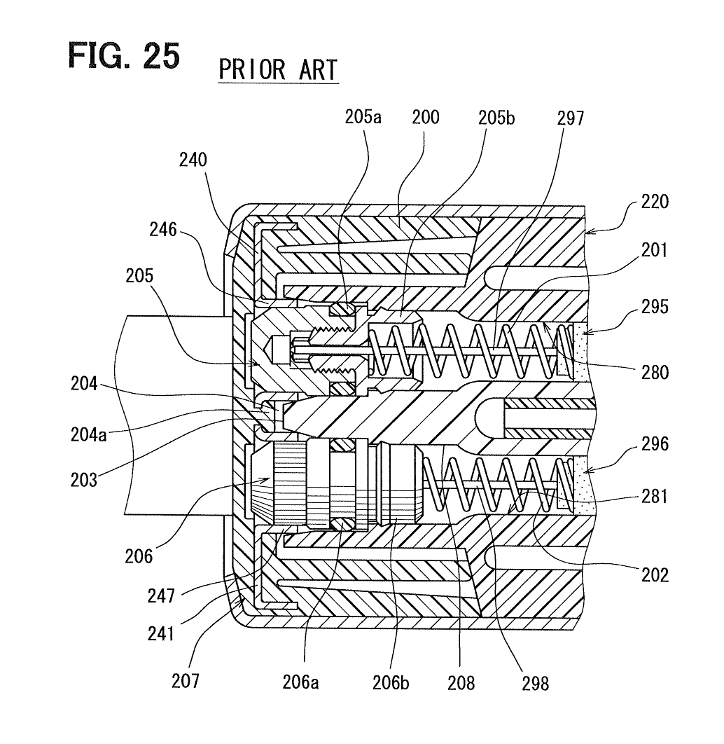

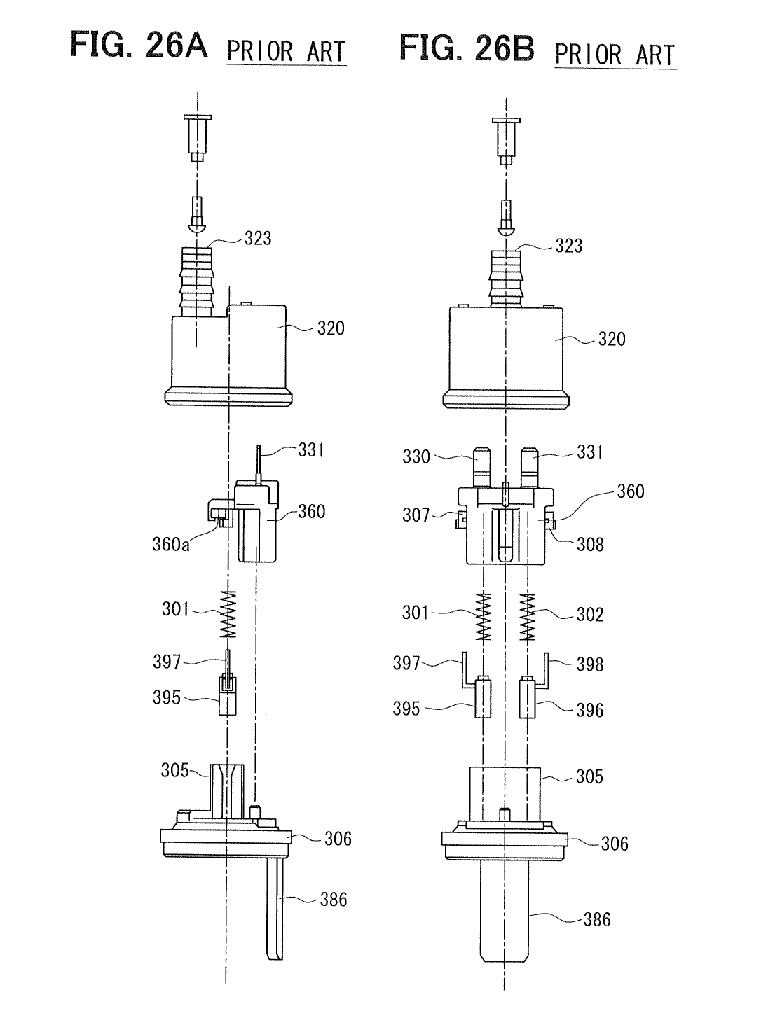

The armature 17 rotates between permanent magnets (not shown) forming a magnetic field. A planar rectifier 18 is attached to the armature 17. A flat surface of the rectifier 18 slidably contacts brushes 195, 196 (refer to FIG. 24).

As shown in FIG. 2, the fuel pump 1 has an end cover 20 made of a synthetic resin. The end cover 20 retains a bearing 21 rotatably supporting the rotational shaft 11 of the motor 10. A pipe-like fuel discharge hole portion 23 protruding from the end cover 20 is formed. A secondary terminal constituting member 70 (explained in detail later) is press-fitted to the end cover 20.

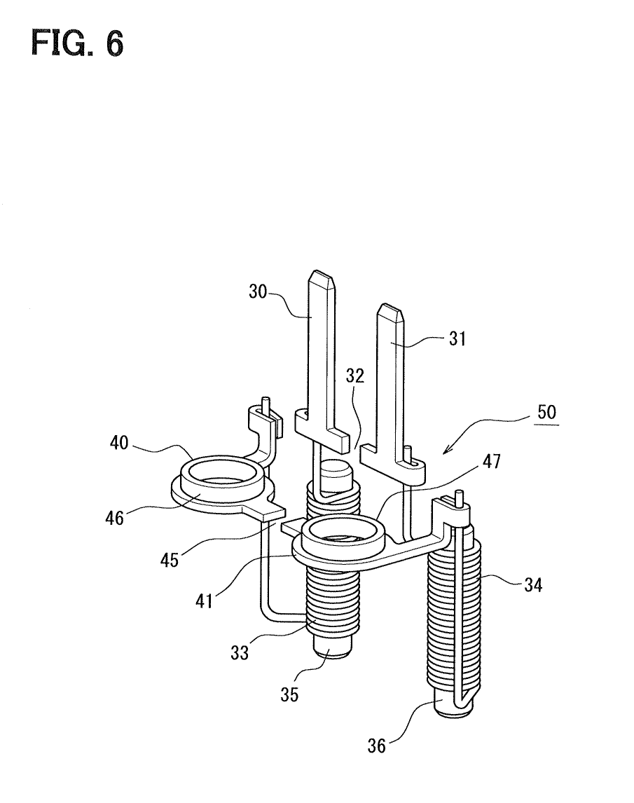

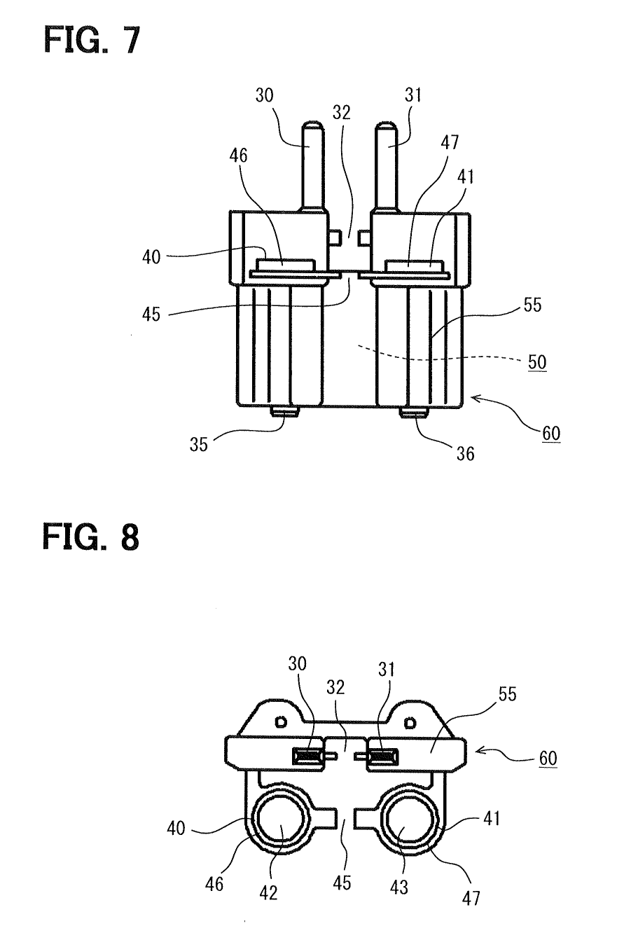

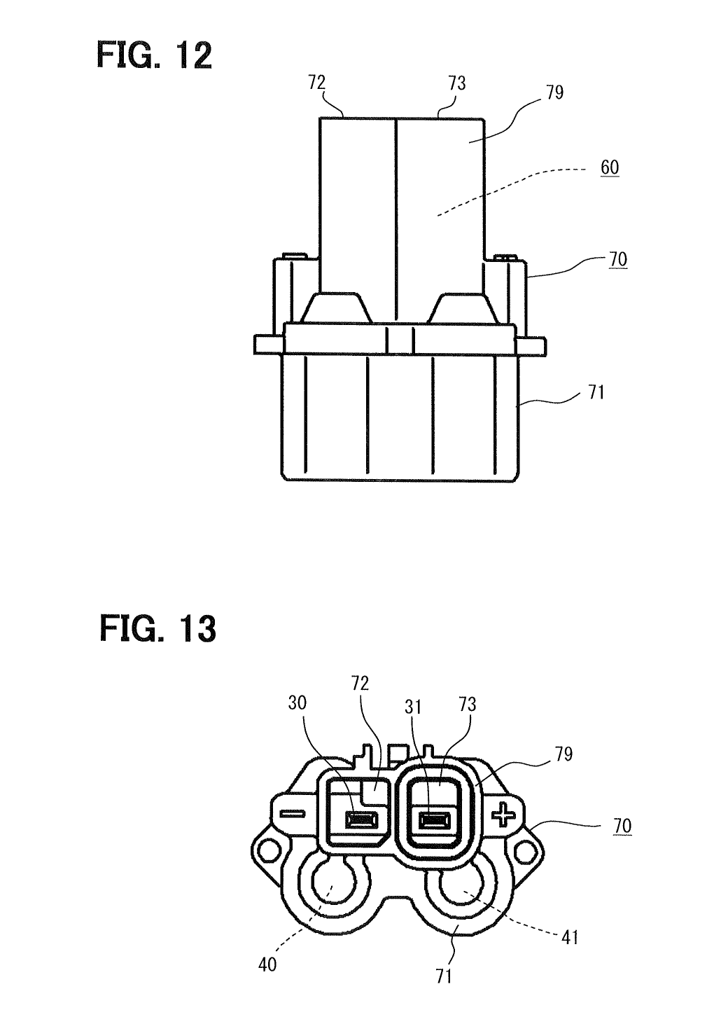

As explained in detail later, an energization member 50 composed of external terminals 30, 31, choke coils 33, 34 and annular terminals 40, 41 (refer to FIG. 6, for example), a primary mold member 55 (refer to FIG. 7, for example) and a secondary mold member 71 (refer to FIG. 12, for example) surrounding the primary mold member 55 are provided inside the secondary terminal constituting member 70. The secondary terminal constituting member 70 constitutes the above-mentioned second member. The end, cover 20 constitutes the above-mentioned first member. Next, the second member will be explained in detail.

(Construction of Second Member)

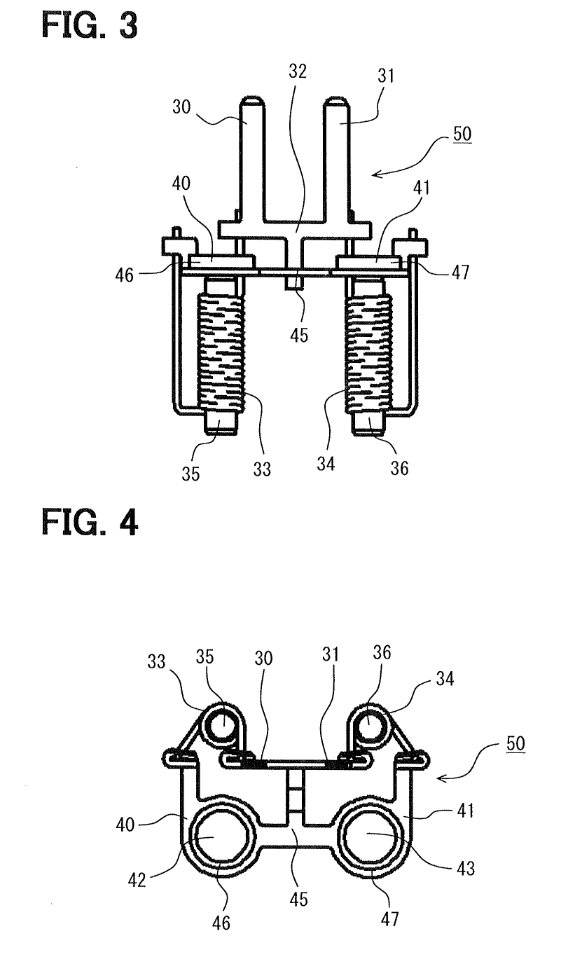

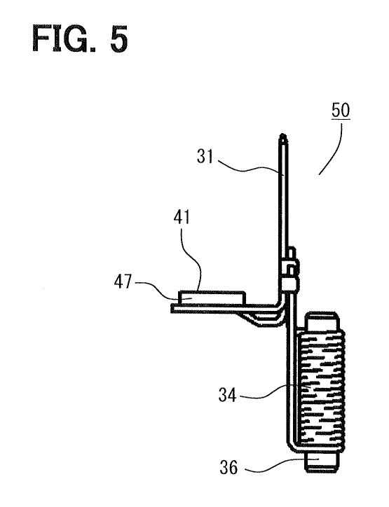

FIG. 3 is a front view showing the energization member 50 in a manufacturing process. As explained in detail later, the energization member 50 is arranged in a primary terminal constituting member 60 in the fuel pump 1 according to the present embodiment. FIG. 4 is a plan view showing the energization member 50 of FIG. 3. FIG. 5 is a right side view showing the energization member 50 of FIG. 3. FIG. 6 is a schematic perspective view showing a segmented energization member 50.

When the motor 10 in the fuel pump 1 is energized, a voltage is applied to the pair of external terminals 30, 31 from an in-vehicle power supply (not shown). Each of the external terminals 30, 31 is formed in a reverse T shape. In the manufacturing process, the external terminals 30, 31 are press-molded and assembled in a state where the external terminals 30, 31 are connected with each other via a connecting portion 32 as shown in FIG. 3. The external terminals 30, 31 are connected with primary sides of the choke coils 33, 34 for radio-noise reduction respectively.

The choke coils 33, 34 are respectively wound around ferrite members 35, 36, each of which is formed in the shape of a circular column. Secondary sides of the choke coils 33, 34 are connected to the annular terminals 40, 41 respectively. The brass annular terminals 40, 41 are composed of terminals having a pair of right and left circular holes 42, 43. Cylindrical ring portions 46, 47 are formed around the circular holes 42, 43 respectively as shown in FIGS. 3 and 4.

The annular terminals 40, 41 having the circular holes 42, 43 are connected with each other via a connecting portion 45 and are formed in the shape of a pair of eyeglasses as a whole in the manufacturing process. Then, primary insert molding (explained in detail later) is performed. After the primary insert molding, the connecting portions 32, 45 are cut. Thus, the energization member 50 is segmented into a positive electrode side member, to which the voltage is applied, and a negative electrode side member as shown in FIG. 6. The mold (i.e., primary mold member 55) is not shown in FIG. 6 for easy understanding of the segmented state of the energization member 50.

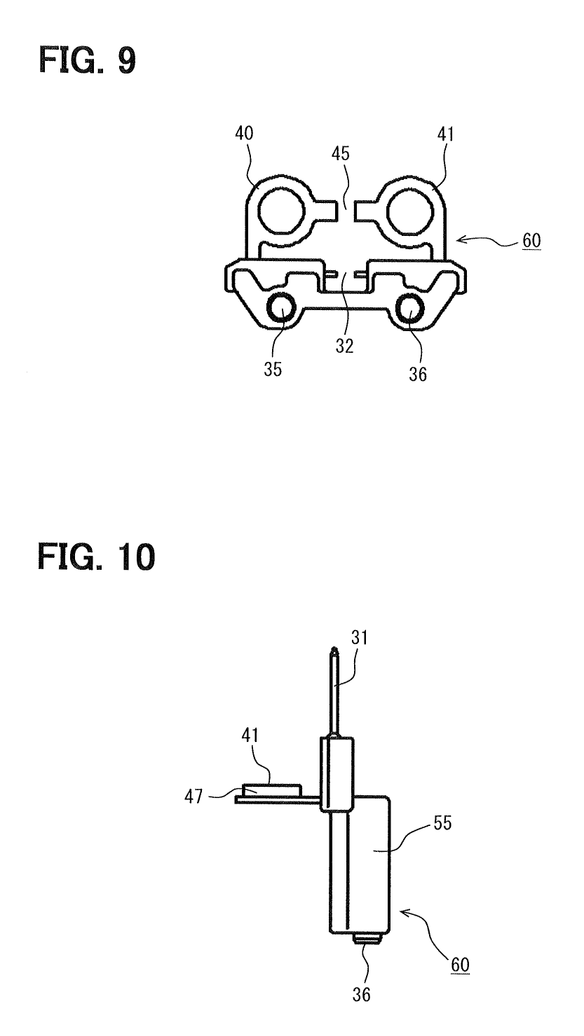

FIG. 7 is a front view showing the primary terminal constituting member 60 formed by covering the energization member 50 with the primary mold member 55 by insert molding. FIG. 8 is a plan view showing the primary terminal constituting member 60 of FIG. 7. FIG. 9 is a bottom view showing the primary terminal constituting member 60 of FIG. 7. FIG. 10 is a right side view showing the primary terminal constituting member 60 of FIG. 7.

The primary insert molding is performed such that the energization member 50, which has the external terminals 30, 31, the choke coils 33, 34 and the annular terminals 40, 41, is inserted in the primary mold member 55 as shown in FIG. 7.

Thus, as shown in FIGS. 7 to 10, end portions of the external terminals 30, 31 on the choke coils 33, 34 side, the choke coils 33, 34, and end portions of the annular terminals 40, 41 on the choke coils 33, 34 side are covered with a synthetic resin forming the primary mold member 55. The synthetic resin of the primary mold member 55 is polyacetal (POM).

As mentioned above, after the primary insert molding of the primary mold member 55, the connecting portions 32, 45 are cut as shown in. FIG. 6. Even if the cutting is performed, the primary mold member 55 prevents scattering of the respective components.

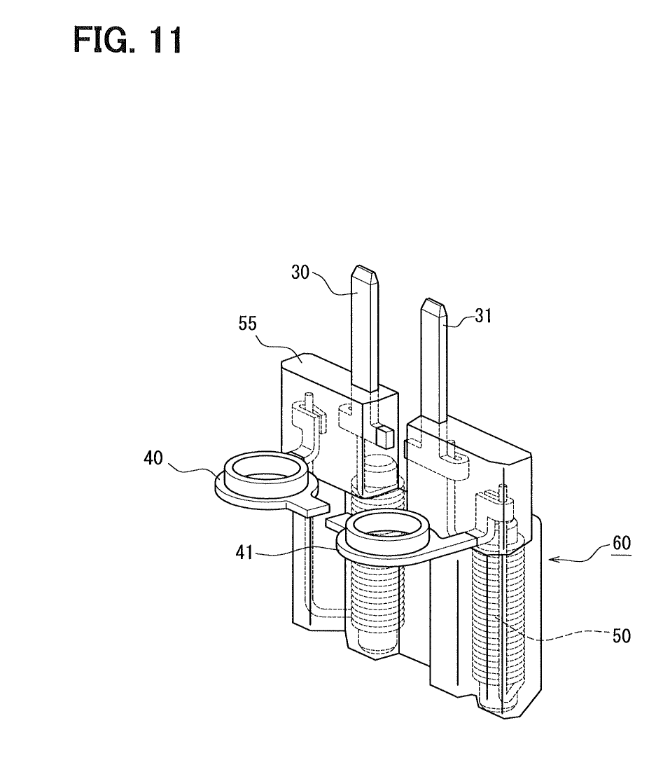

Hereafter, the assembly of the energization member 50 and the primary mold member 55 shown in FIG. 11 after the primary insert molding will be referred to as the primary terminal constituting member 60. FIG. 11 is a schematic perspective view showing the primary terminal constituting member 60. In FIG. 11, for easy understanding of an internal construction, the opaque synthetic resin of the primary mold member 55 is illustrated as if it were transparent.

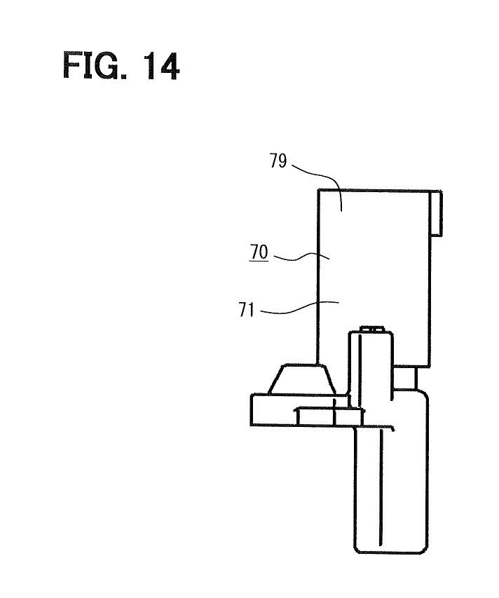

Then, the secondary terminal constituting member 70 is formed by applying secondary insert molding to the primary terminal constituting member 60 shown in FIG. 11. FIG. 12 is a front view showing the secondary terminal constituting member 70. FIG. 13 is a plan view showing the secondary terminal constituting member 70 of FIG. 12. FIG. 14 is a right side view showing the secondary terminal constituting member 70 of FIG. 12

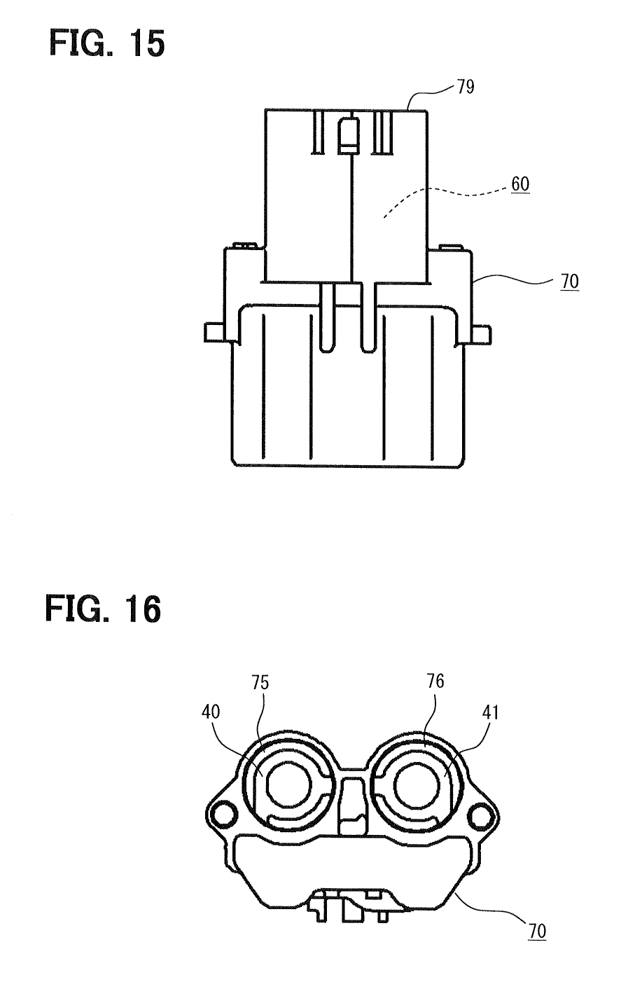

FIG. 15 is a back view showing the secondary terminal constituting member 70 of FIG. 12. FIG. 16 is a bottom view showing the secondary terminal constituting member 70 of FIG. 12.

With the secondary insert molding, the synthetic resin forming the primary mold member 55 and the like are covered with an insulative synthetic resin forming the secondary mold member 71.

Tip portions of the external terminals 30, 31, which are not covered with the synthetic resin forming the primary mold member 55 shown in FIG. 7, are surrounded by the synthetic resin forming the secondary mold member 71, thereby forming opening portions 72, 73 as shown in FIG. 13.

The annular terminals 40, 41 shown in FIG. 11 are covered with the synthetic resin forming the secondary mold member 71 such that bottom opening portions 75, 76 shown in FIG. 16 are left uncovered. Thus, when viewed from the bottom side, only the annular terminals 40, 41 are visible among the parts of the primary terminal constituting member 60 as shown in FIG. 16.

As shown in FIGS. 12 and 13, the secondary mold member 71 surrounding the tip end portions of the external terminals 30, 31 constitutes a male connector portion 79. A female connector portion (not shown) on a vehicle side is connected to the connector portion 79 to apply a voltage to the external terminals 30, 31.

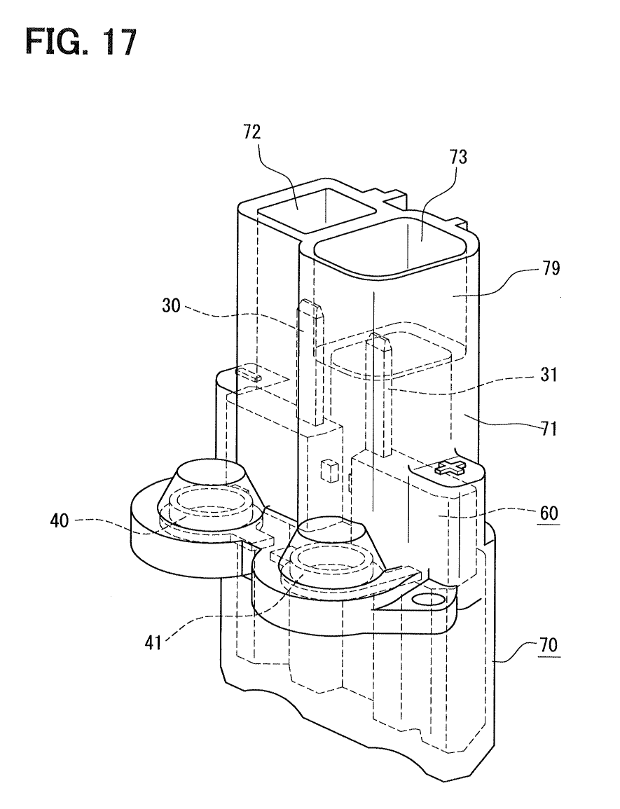

FIG. 17 is a schematic perspective view showing the secondary terminal constituting member 70 formed by applying the secondary insert molding to the primary terminal constituting member 60 using the secondary mold member 71. In FIG. 17, for easy understanding of an internal construction, the opaque synthetic resin of the secondary mold member 71 is illustrated as if it were transparent.

(Construction of First Member)

As explained with reference to FIG. 2, the secondary terminal constituting member 70 constitutes the second member, and the end cover 20 constitutes the first member. Hereinafter, the end cover 20 as a main part of the first member will be explained.

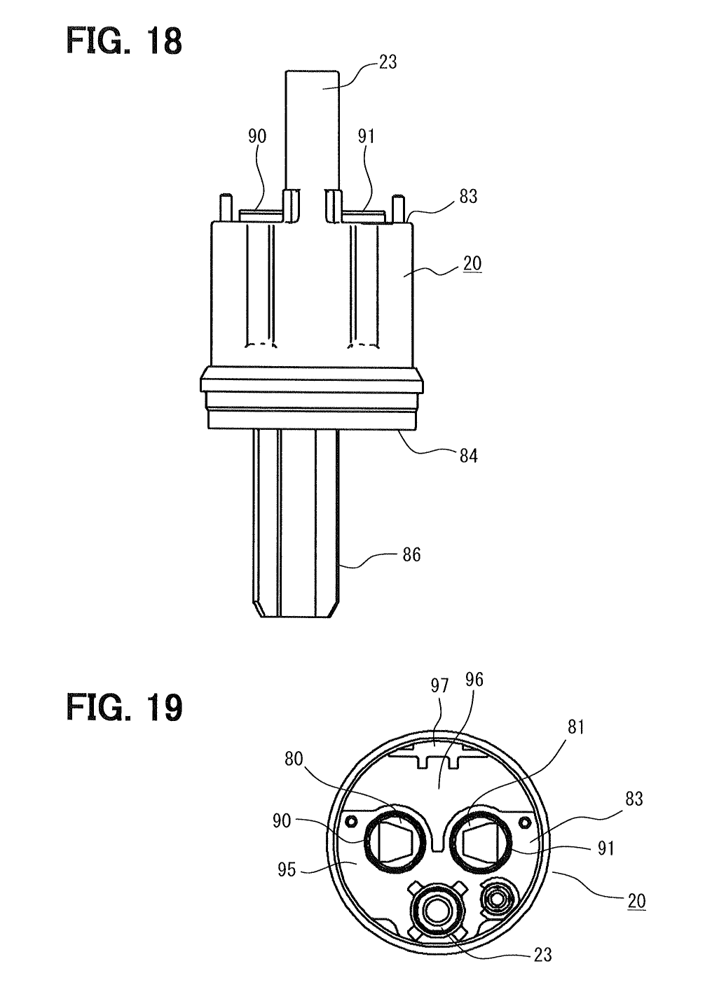

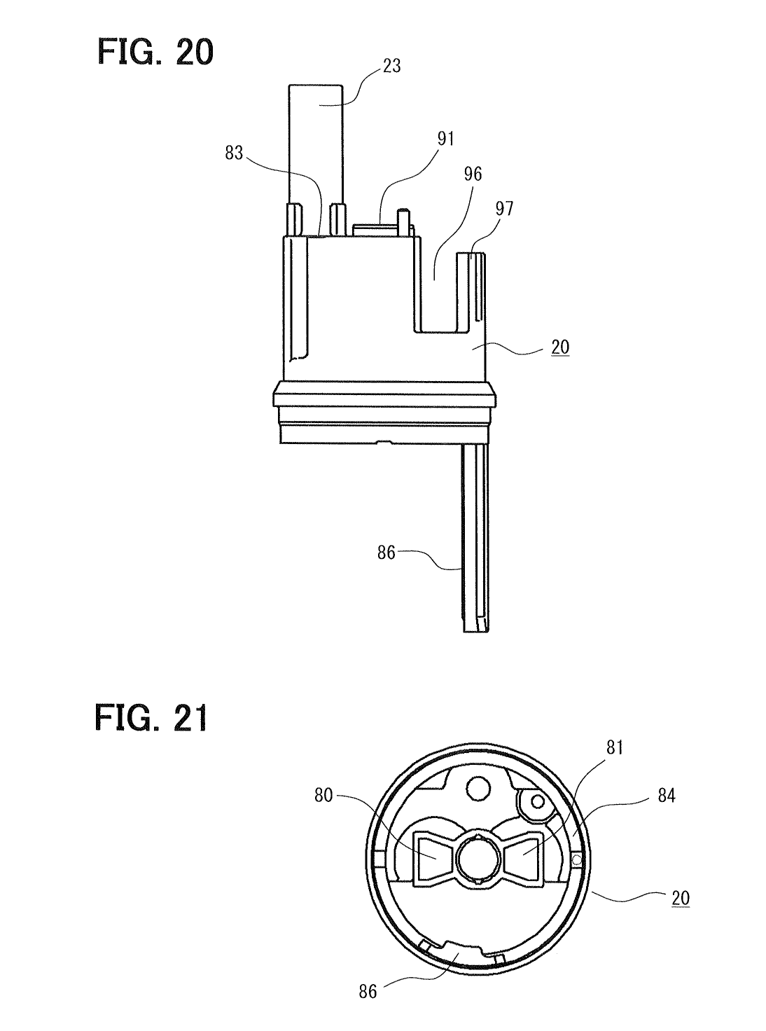

FIG. 18 is a front view showing the end cover 20 according to the present embodiment. FIG. 19 is a plan view showing the end cover 20 of FIG. 18. FIG. 20 is a right side view showing the end cover 20 of FIG. 18. FIG. 21 is a bottom view showing the end cover 20 of FIG. 18. As shown in the plan view of FIG. 19, the end cover 20 constructed of a molded product of a synthetic resin has two brush insertion holes 80, 81. The end cover 20 has a top surface side end portion 83 as shown in FIGS. 18 to 20. The end cover 20 has a bottom surface side end portion 84 as shown in FIGS. 18 and 21.

The ends of the brush insertion holes 80, 81 on the top surface side end portion 83 side are formed in circular hole shapes as shown in FIG. 19. Lower ends of the brush insertion holes 80, 81 are formed in trapezoidal hole shapes as shown in FIG. 21. The pipe-like fuel discharge hole portion 23 protrudes upward from the end cover 20. An insertion protrusion 86 to be inserted into the housing 4 is formed on a lower end surface of the end cover 20.

Cylindrical metallic collar members 90, 91 are embedded in the pair of brush insertion holes 80, 81 respectively such that tip ends of the collar members 90, 91 are not embedded. Thus, parts of the collar members 90, 91 protrude from the end cover 20. The collar members 90, 91 are inserted into the end cover 20 by the insert molding.

In FIG. 19, a recessed portion 96 and a guiding protrusion 97 are formed in a planar portion 95 positioned at the same height as the top surface side end portion 83 of the end cover 20. The secondary terminal constituting member 70 shown in FIGS. 12 to 17 is inserted into the recessed portion 96.

A pair of brushes 195, 196 for a positive electrode side and a negative electrode side, pigtails 197, 198 connected to the brushes 195, 196 respectively, a pair of brush springs 101, 102, and a pair of brush terminals 105, 106 connected to end portions of the pigtails 197, 198 on an opposite side from the brushes 195, 196 by soldering are inserted into the brush insertion holes 80, 81 as described in detail later (refer to FIG. 24).

The brush terminals 105, 106 are press-fitted into the collar members 90, 91 (refer to FIG. 24). However, FIGS. 18 to 21 show a state before the brushes 195, 196, the pigtails 197, 198, the brush springs 101, 102 and the brush terminals 105, 106 are inserted into the brush insertion holes 80, 81.

(Construction of Assembly of First Member and Second Member)

Next, a construction of an assembly, which is provided by assembling the secondary terminal constituting member 70 constituting the second member and the end cover 20 constituting the first member after the brushes 195, 196, the pigtails 197, 198, the brush springs 101, 102 and the brush terminals 105, 106 are inserted into the brush insertion holes 80, 81, will be explained.

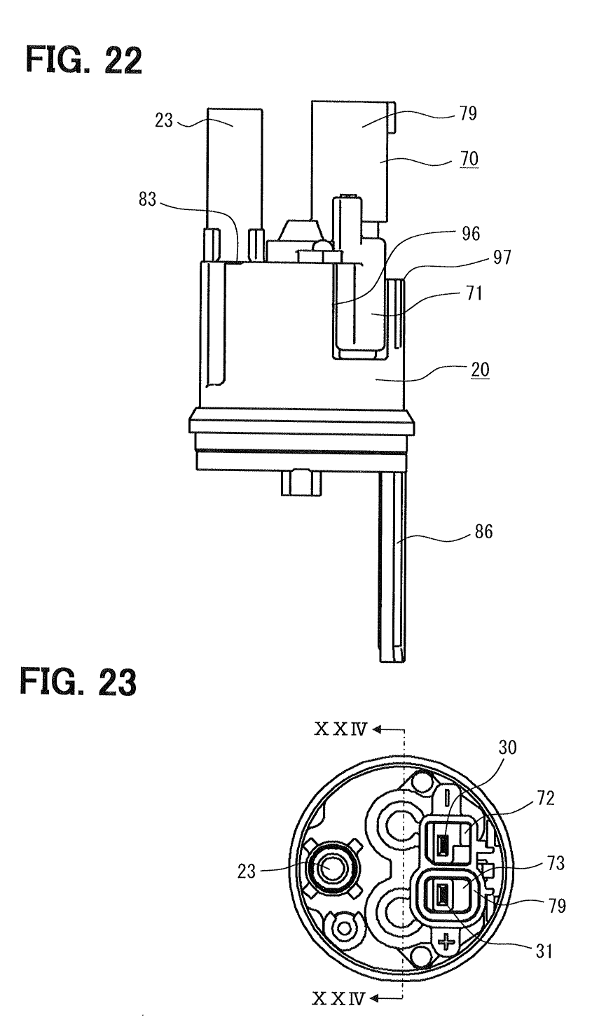

FIG. 22 is a front view showing the construction provided by assembling the secondary terminal constituting member 70 and the end cover 20. FIG. 23 is a plan view showing the construction of FIG. 22. FIG. 24 is an enlarged partial cross-sectional view of the construction of FIG. 23 taken along the line XXIV-XXIV.

As shown in FIGS. 22 and 23, the secondary terminal constituting member 70 constituting the second member and the end cover 20 constituting the first member are assembled. The secondary terminal constituting member 70 is inserted into the recessed portion 96 of the end cover 20.

As shown in FIG. 24, parts of the metallic collar members 90, 91 protrude from a plane, which has the same height as the top surface side end portion 83 of the end cover 20. That is, the cylindrical metallic collar members 90, 91 are partly inserted into the synthetic resin of the end cover 20 around the openings of the pair of brush insertion holes 80, 81 on the fuel discharge hole portion 23 side by the insert molding.

The brushes 195, 196, which the rectifier 18 slidably contacts, the pigtails 197, 198 providing connection wires connected to the brushes 195, 196, the brush springs 101, 102, and the brush terminals 105, 106 connected to the end portions of the pigtails 197, 198 on an opposite side from the brushes 195, 196 at soldered portions 103, 104 are inserted in the brush insertion holes 80, 81 as shown in FIG. 24.

The brush terminals 105, 106 are press-fitted into the collar members 90, 91, thereby fixing the brush terminals 105, 106. The pigtails 197, 198 extend from the soldered portions 103, 104 through the brush terminals 105, 106 and are fixed to the brushes 195, 196 by soldering.

The energization member 50 composed of the external terminals 30, 31, the choke coils 33, 34 and the annular terminals 40, 41, the primary mold member 55 and the secondary mold member 71 covering the primary mold member 55 are provided in the secondary terminal constituting member 70 shown in FIG. 22.

The fixed brush terminals 105, 106 are covered with the cylindrical ring portions 46, 47 of the annular terminals 40, 41 of the secondary terminal constituting member 70 from the fuel discharge hole portion 23 side as shown in FIG. 24. The brush terminals 105, 106 are press-fitted into the cylindrical ring portions 46, 47. Thus, the secondary terminal constituting member 70 is press-fitted into and combined with the recessed portion 96 of the end cover 20 as shown in FIG. 22.

While the annular terminals 40, 41 shown in FIG. 24 are press-fitted to the brush terminals 105, 106, outer peripheral portions of the collar members 90, 91, which are inserted in the end cover 20, are press-fitted into a resin portion of the secondary mold member 71 around the pair of annular terminals 40, 41. Since the outer peripheries of the collar members 90, 91 are press-fitted into the secondary mold member 71 in this way, close contact can be secured between the collar members 90, 91 and the resin of the secondary mold member 71. Accordingly, the fuel can be prevented from intervening between the electrode portions composed of the brush terminals 105, 106 or the annular terminals 40, 41 having a potential difference. Thus, the electrode portions can be electrically separated from each other completely to prevent the electric corrosion.

In this way, the secondary terminal constituting member 70 is inserted into the recessed portion 96 of the end cover 20 by using the guiding protrusion 97 as a guide member. Thus, narrow diameter portions of the stepped brush terminals 105, 106 are press-fitted into the cylindrical ring portions 46, 47 of the annular terminals 40, 41 in the secondary terminal constituting member 70 respectively as shown in FIG. 24. Thus, the brushes 195, 196 are connected to the secondary sides of the choke coils 33, 34 through the pigtails 197, 198, the soldered portions 103, 104 and the annular terminals 40, 41.

(Operation)

Next, an operation of the fuel pump 1 according to the present embodiment will be explained. If the female connector portion (not shown) connected to the power supply on the vehicle side is connected to the connector portion 79 around the external terminals 30, 31 shown in FIG. 23, a direct current flows through the external terminals 30, 31, the choke coils 33, 34, the annular terminals 40, 41, the brush terminals 105, 106, the pigtails 197, 198, the brushes 195, 196, and the rectifier 18. As a result, the motor 10 rotates and the impeller 8 rotates.

The fuel pressurized by the rotation of the impeller 8 flows through the periphery of the motor 10 and flows out of the fuel discharge hole portion 23. At this time, the brush insertion holes 80, 81 are filled with the fuel.

In order to prevent the brush terminals 105, 106 from coming off due to the fuel pressure, the soldered portions 103, 104 in the narrow diameter portions of the brush terminals 105, 106 and press-fitting portions 105c, 106c consisting of metals of the brush terminals 105, 106 and the collar members 90, 91 constitute a retaining structure. The tip end portions of the collar members 90, 91 are press-fitted into the secondary mold member 71 around the annular terminals 40, 41 as shown in FIG. 24. Accordingly, the collar members 90, 91 and the resin of the secondary mold member 71 closely contact each other to prevent the entrance of the fuel.

The fuel does not intervene between the conductive portions such as the pair of collar members 90, 91 or the pair of annular terminals 40, 41. Therefore, even if a highly conductive component is contained in the fuel, leak current, which is a cause of the electric corrosion, does not flow.

Thus, the sealing performance between the positive electrode side and the negative electrode side is secured, and the leak current from the positive electrode side metal to the negative electrode side metal is prevented. Thus, the electric corrosion action in the conductive portions on both sides of the positive electrode side and the negative electrode side is suppressed.

According to the present embodiment, the collar members 90, 91 are embedded in the end cover 20, and the brush terminals 105, 106 connected to the brushes 195, 196 through the pigtails 197, 198 are press-fitted into the collar members 90, 91, thereby preventing the coming off of the brush terminals 105, 106. The peripheries of the brush terminals 105, 106 are surrounded by the close contact structure between the collar members 90, 91 and the resin. Thus, the anti-electric corrosion sealing structure can be realized by the two-member construction composed of the end cover 20 and the secondary terminal constituting member 71.

(Assembling Method)

Next, an assembling method of the fuel pump 1 shown in FIG. 2 will be explained. The energization member 50 shown in FIG. 3 composed of the external terminals 30, 31, the choke coils 33, 34 and the annular terminals 40, 41 is inserted in the primary mold member 55 by the primary insert molding. Thus, the primary terminal constituting member 60 is formed as shown in FIG. 7.

The secondary insert molding is applied to the primary terminal constituting member 60 using the secondary mold member 71. Thus, the secondary terminal constituting member 70 is formed as shown in FIG. 12.

As shown in FIGS. 18 to 21, the end cover 20 having the recessed portion 96, into which the secondary terminal constituting member 70 can be inserted, the brush insertion holes 80, 81 and the collar members 90, 91, which are inserted to the inner peripheries of the brush insertion holes 80, 81 by the insert molding, is provided.

The end cover 20, in which the brushes 195, 196, the pigtails 197, 198, the brush springs 101, 102, and the brush terminals 105, 106 connected to end portions of the pigtails 197, 198 on the opposite side from the brushes 195, 196 by the soldering are inserted into the brush insertion holes 80, 81, is prepared. In this way, the secondary terminal constituting member 70 constituting the second member and the end cover 20 constituting the first member are prepared as the components to be assembled.

In the assembly, first, the pump housings 6, 7, the impeller 8 and the motor 10 are inserted into the housing 4 formed of a cylindrical metal. Then, a part of the end cover 20 is inserted into the housing 4, and the rotational shaft 11 of the motor 10 is rotatably supported on both sides of the armature 17 by the bearing 21 held by the end cover 20 and the bearing 13 held by the pump housing 6 as shown in FIG. 2.

The secondary terminal constituting member 70 is press-fitted into the end cover 20 such that the brush terminals 105, 106, which are press-fitted and fixed to the collar members 90, 91 inserted in the end cover 20, are covered with and press-fitted into the cylindrical ring portions 46, 47 of the annular terminals 40, 41 as shown in FIG. 24. At the same time, the tip end portions of the collar members 90, 91 are press-fitted into the resin of the secondary mold member 71. Thus, the resin of the end cover 20 and the resin of the secondary terminal constituting member 70 are connected with each other through the outer peripheries of the collar members 90, 91 protruding from the end cover 20. Both end portions of the housing 4 are clamped to the end cover 20 and the pump housing 7 as shown in FIG. 2.

(Main Construction of Embodiment)

A main construction and action of the above embodiment will be explained below. The collar members 90, 91 inserted in the end cover 20 by the insert molding are provided in the end portions of the brush insertion holes 80, 81 of the end cover 20 on the opposite side from the brushes 195, 196. The brush terminals 105, 106 press-fitted into the collar members 90, 91 and connected to the brushes 195, 196 are provided.

The fuel leakage is prevented by the press-fitting portions 105c, 106c between the collar members 90, 91 and the brush terminals 105, 106. The brush terminals 105, 106 protruding outward further than the tip end portions of the collar members 90, 91 are press-fitted into the cylindrical ring portions 46, 47 of the annular terminals 40, 41. Therefore, tight electrical and mechanical connection can be achieved between the annular terminals 40, 41 and the brush terminals 105, 106.

The collar members 90, 91 are inserted in the end cover 20 by the insert molding such that the tip end portions of the collar members 90, 91 protrude from the end cover 20. The annular terminals 40, 41 are partly inserted in the secondary mold member 71 of the secondary terminal constituting member 70 by the molding.

The synthetic resin of the end cover 20 and the synthetic resin of the secondary mold member 71 around the annular terminals 40, 41 are combined with each other through the outer peripheries of the tip end portions of the collar members 90, 91. Accordingly, the resin of the end cover 20 and the resin of the secondary terminal constituting member 70 are combined with each other through the outer peripheries of the tip end portions of the collar members 90, 91. Therefore, the resins can be strongly combined with each other to surely put the resin in the route of the current flow. Thus, the leak current can be prevented, and the electric corrosion can be prevented.

The secondary terminal constituting member 70 is inserted into the recessed portion 96 of the end cover 20 and is press-fitted into the end cover 20. Therefore, the end cover 20 and the secondary terminal constituting member 70 can be easily assembled and the combining force can be increased.

As shown in FIG. 22, the guiding protrusion 97 that faces one wall surface of the recessed portion 96 and that provides the other wall surface of the recessed portion 96 is provided. The wall surface of the guiding protrusion 97 is lower than the one wall surface of the recessed portion 96.

The other wall surface of the recessed portion 96 is lower than the one wall surface of the recessed portion 96. Therefore, the secondary terminal constituting member 70 can be positioned by bringing the secondary terminal constituting member 70 into contact with the higher one wall surface of the recessed portion 96. Thus, the secondary terminal constituting member 70 can be easily inserted into the recessed portion 96.

The end cover 20 has the brush insertion holes 80, 81 for receiving the brushes 195, 196 and constitutes the first member. The collar members 90, 91 are inserted in the brush insertion holes 80, 81. The brush terminals 105, 106 connected to the brushes 195, 196 are press-fitted into the collar members 90, 91.

The external terminals 30, 31 and the annular terminals 40, 41 are partly inserted in the mold to form the primary terminal constituting member 60, from which the external terminals 30, 31 and the annular terminals 40, 41 are partly exposed.

The periphery of the primary terminal constituting member 60 is covered with the secondary mold member 71 by the molding, thereby forming the secondary terminal constituting member 70 constituting the second member. The secondary terminal constituting member 70 constituting the second member is assembled to the end cover 20 constituting the first member. Thus, the brush terminals 105, 106 of the end cover 20 are press-fitted into the annular terminals 40, 41. Thus, the assembly can be manufactured simply by assembling the two members of the first member and the second member.

### Other Embodiment

The present invention is not limited to the aforementioned embodiment but may be modified and implemented, for example, as follows.

In the above embodiment, the in-tank fuel pump is used. Alternatively, a fuel pump mounted in a pipe outside the tank may be used.

In the above embodiment, the regenerative pump 1 is used. Alternatively, different type pumps other than a positive displacement pump may be used. Alternatively, a positive displacement pump may be used.

When the motor 10 in the fuel pump 1 is energized, a voltage is applied from the in-vehicle power supply to the external terminals 30, 31, each of which is formed in the reverse T shape. The pair of external terminals 30, 31 are formed by press molding such that the external terminals 30, 31 are connected with each other. The primary insert molding is applied to the pair of external terminals 30, 31 and the pair of annular terminals 40, 41 in the state where the external terminals 30, 31 are connected with each other and the annular terminals 40, 41 are connected with each other. Thereafter, the connecting portions 32, 45 are cut.

Alternatively, a pair of already segmented external terminals and a pair of already segmented annular terminals may be prepared and may be fixed by fixing jigs. In that state, the primary insert molding may be applied to the already segmented terminals.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A fuel pump for pressurizing fuel by driving a rotational member in a pump housing with a motor, the fuel pump being manufactured by a process comprising:
forming a first member from brushes, which a rectifier of the motor slidably contacts, an end cover, which has brush insertion holes for receiving the brushes and which is connected to a housing accommodating the motor, collar members partly inserted in the end cover at end portions of the brush insertion holes on an opposite side from the brushes by insert molding such that tip ends of the collar members protrude from the end cover, and brush terminals inserted into the collar members and connected to the brushes,
forming a second member from annular terminals, external terminals, which are connected to the annular terminals and supplied with an electric power from an outside of the fuel pump, a primary mold member for partly covering the external terminals and the annular terminals, and a secondary mold member, which covers the primary mold member such that the secondary mold member covers parts of the annular terminals and which has a connector portion surrounding the external terminals,
combining the secondary mold member to the end cover to press-fit the brush terminals into the annular terminals; and
press-fitting the tip end portions of the collar members into the secondary mold member around the annular terminals.

2. The fuel pump as in claim 1, wherein
the brush terminals are press-fitted into the collar members to prevent the brush terminals from coming off and to prevent entrance of the fuel.

3. The fuel pump as in claim 1, wherein
the annular terminals have cylindrical ring portions, and
the brush terminals protrude further than the tip end portions of the collar members to an outside and are press-fitted into the cylindrical ring portions.

4. The fuel pump as in claim 1, wherein
the end cover has a planar portion integrated with a fuel discharge hole portion, from which the fuel from a fuel passage around the motor is discharged, and has a recessed portion recessed in an axial direction of the motor from the planar portion adjacent to the fuel discharge hole portion, and
the secondary mold member is inserted in the recessed portion of the end cover to be combined with the end cover.

5. The fuel pump as in claim 1, wherein
the end cover has a guiding protrusion that faces one wall surface of the recessed portion and that provides the other wall surface of the recessed portion, and
the other wall surface of the recessed portion is formed to be lower than the one wall surface of the recessed portion.

6. A fuel pump for pressurizing fuel by driving a rotational member in a pump housing with a motor, the fuel pump comprising:
a first member formed from brushes, which a rectifier of the motor slidably contacts, an end cover, which has brush insertion holes for receiving the brushes and which is connected to a housing accommodating the motor, collar members partly inserted in the end cover at end portions of the brush insertion holes on an opposite side from the brushes by insert molding such that tip ends of the collar members protrude from the end cover, and brush terminals inserted into the collar members and connected to the brushes, and
a second member formed from annular terminals, external terminals, which are connected to the annular terminals and supplied with an electric power from an outside of the fuel pump, a primary mold member for partly covering the external terminals and the annular terminals, and a secondary mold member, which covers the primary mold member such that the secondary mold member covers parts of the annular terminals and which has a connector portion surrounding the external terminals, wherein
the secondary mold member is combined to the end cover to press-fit the brush terminals into the annular'terminals, and
the tip end portions of the collar members are press-fitted into the secondary mold member around the annular terminals.

7. A manufacturing method of a fuel pump having a motor, which is accommodated in a housing and which drives a rotational member in a pump housing, the manufacturing method comprising the steps of:
forming an end cover by insert molding such that the end cover has brush insertion holes for receiving brushes, which slidably contact a rectifier of the motor, and such that collar members except tip portions thereof are inserted in the brush insertion holes;
press-fitting brush terminals connected with the brushes into the collar members in the brush insertion holes of the molded end cover;
molding a primary mold member to cover parts of a pair of external terminals, via which an electric power is supplied to the motor from an outside of the fuel pump, and parts of a pair of annular terminals connected to the external terminals with the primary mold member such that the other parts of the external terminals and the other parts of the annular terminals are exposed to an outside of the primary mold member;
molding a secondary mold member around the primary mold member to form a connector portion, which surrounds the external terminals, with the secondary mold member; and
assembling the secondary mold member to the end cover such that the tip end portions of the collar members are press-fitted into the secondary mold member around the annular terminals and such that the brush terminals of the end cover are press-fitted into the annular terminals.

8. The manufacturing method as in claim 7, wherein the molding the primary mold member is performed to cover the pair of external terminals and the pair of annular terminals with the primary mold member in a state where the pair of external terminals are connected with each other via a connecting portion and the pair of annular terminals are connected with each other via another connecting portion, the manufacturing method further comprising the step of:
cutting the connecting portions after the molding the primary mold member and before the molding the secondary mold member.
